(19) United States
(12) Patent Application Publication
(10) Pub. No.: US 2018/0188697 A1
(43) Pub. Date: Jul. 5, 2018

(54) Personal Communication and Alert Device

(71) Applicants: Heather Urban, Menifee, CA (US); Renee L. Finnis, Menifee, CA (US)

(72) Inventors: Heather Urban, Menifee, CA (US); Renee L. Finnis, Menifee, CA (US)

(21) Appl. No.: 15/856,361

(22) Filed: Dec. 28, 2017

Related U.S. Application Data
(60) Provisional application No. 62/441,042, filed on Dec. 30, 2016.

(51) Int. Cl. G04G 21/04; H04B 1/3827

(52) U.S. Cl. CPC G04G 21/04; H04B 2001/3894; H04B 1/385

(57) ABSTRACT

A pair of wireless watch-like wristbands with radio frequency transmission and reception capabilities, for the purpose of locating, alerting, and communicating important information to and from persons; a wireless communications system designed to summon persons such as children back to a pre-arranged meeting site at the press of a button; a waterproof wireless communications system to summon a person.

### CLAIM OF PRIORITY

This patent application claims priority under 35 USC 119 (e) (1) from U.S. Provisional Patent Application Ser. No. 62/441,042 filed 12/30/2016, of Heather Urban and Renee Haynes entitled, “Return to Camp,” which is incorporated herein by reference as though the same were set forth in its entirety.

### FIELD OF THE INVENTION

The present invention pertains to the field of wireless communications systems, and more specifically to the field of wireless communications systems designed to communicate and summon persons such as children back to a pre-arranged meeting site at the press of a button.

### BACKGROUND OF THE INVENTION

Millions of families across the country conduct activities that includes taking the kids to the beach, or on a camping trip, a trip to a water-park or historical site or outdoor festival, or on a cruise. In all of these cases and more, what the parents need is a way to effectively call their kids “back to camp”, i.e., back to a pre-arranged meeting site, when the parents and children are in different locations. For that matter, parents need a way of summoning children home for supper when they are dispersed, out visiting friends or playing in the neighborhood. Further, should a child become lost on an outing, a parent or other caretaker needs some means of tracking and locating that child, and quickly.

The prior art has put forth several designs for wireless communication systems. Among these are:

US Patent Application No. 2010/0238033 to Dan Blumel provides a tracking device, system, and method that may utilize GPS, global system for mobile communications (GSM) or general packet radio service (GPRS), including using triangulation, and/or wireless local area network (WLAN) technologies to improve the scope, range, reliability, convenience and speed of current tracking devices. The invention may employ a wearable or attachable device to track persons, such as children or the elderly, or objects, for example. Unauthorized removal, destruction, or tampering of the tracking device may result in alerts being sent out to a variety of monitoring stations. The tracking and alerts may be monitored via a convenient remote monitoring interface.

US Patent Application No. 200410080420 to Marjorie Roberts provides a set of radio controlled devices having a “pager style” receiver unit and a transmitter bracelet. Bracelets are intended to accommodate parents in the safety of their children in crowded malls, sporting events and other public settings. The pager unit and the bracelet act interdependently upon a radio signal transmission between the set. An adult wears the main pager unit and the safety bracelet is to be worn by their child. Sets will be packaged to accommodate families of all sizes. The operation of the bracelet is set to a determined distance, if the child is moved from the set parameter an alarm will sound on both the adult's and child's unit. Additionally, an alarm will sound if the bracelet is moved or tampered with in any way. When the alarm is sounded it will thereby alert the parent and others surrounding the child to the danger imposed, and giving an instant warning to suppress any threat.

U.S. Pat. No. 7,602,303 to Randy Douglas provides a bracelet that can transmit the location of the wearer to a monitoring station using GPS technology to locate the wearer and cellular communication technology to transmit the information. The apparatus can also record and transmit sound and visual information to the monitoring station and receive sound transmissions from the monitoring station. Another embodiment of the apparatus includes a two unit version were one unit can detect the distance to the other unit. Once that distance exceeds a certain maximum, an alarm will sound from the first unit. An alarm can also be sent to the monitoring station.

None of these prior art references describe the present invention.

### SUMMARY OF THE INVENTION

It is an object of the present invention to provide a wireless communications system designed to summon persons such as children back to a pre-arranged meeting site at the press of a button.

It is a further object of the present invention to provide a waterproof wireless communications system to summon a person.

It is a still further object of the present invention to provide a wireless communications system to summon a person suitable for use in Search and Rescue, by firemen, and emergency responders.

### BRIEF DESCRIPTION OF THE DRAWINGS

FIG. 1 is a front perspective view showing the transmitter bracelet in accordance with the present invention.

FIG. 2 is a perspective view illustrating the receiver bracelet constructed in accordance with the present invention.

### DETAILED DESCRIPTION OF THE INVENTION

The present invention consists of a pair of wireless watch-like wristbands with radio frequency transmission and reception capabilities, for the purpose of locating, alerting, and communicating important information to and from persons.

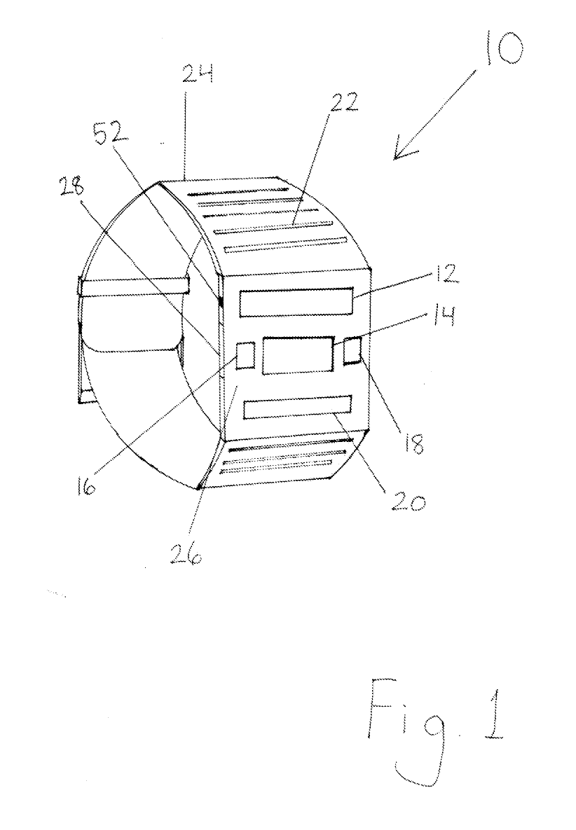

Please refer to the drawings. In a preferred embodiment, shown in FIG. 1, the transmitter bracelet, hereafter indicated by 10, consists of a transmitter wristband 24, transmitter face 26, and transmitter battery compartment 28. Bracelet 10 features transmitter LED panel 12. Bracelet 10 is equipped with an alert activation button 14. Bracelet 10 features an LED 16. Additionally, bracelet 10 has a vibration activation button 18. Bracelet 10 also has a deactivation button 20. Bracelet 10 also features transmitter photovoltaic cells 22. In an embodiment, the transmitter bracelet 10 can be waterproof.

Transmitter wristband 24 can be made of any suitable material, including, but not limited to: cotton, plastic, nylon, hypoallergenic fiber, rubber, silicone, viscoelastic foam, EVA foam, closed cell resin foam, or other suitable material.

The alert activation button 14 is centered on the transmitter face 26 of the transmitter bracelet 10. Situated above the alert activation button 14, is the transmitter LED panel 12. When the user is looking at the LED panel 12, the alert activation button 14 is positioned to the left of LED 16. To the right of the alert activation button 14 is a vibration activation button 18. Below the alert activation button 14 is a deactivation button 20. The transmitter photovoltaic cells 22 are situated on the transmitter wristband 24.

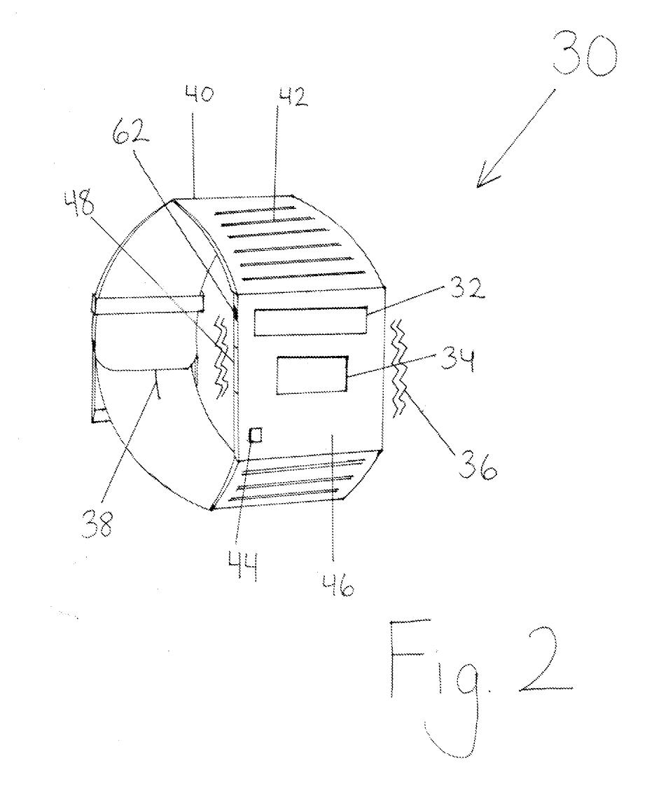

As shown in FIG. 2, the receiver bracelet 30 consists of a receiver wristband 40, receiver face 46, and receiver battery compartment 48. Receiver bracelet 30 features receiver LED panel 32. Receiver bracelet 30 has an alert panel 34. The receiver bracelet 30 features a vibration function 36. The receiver bracelet 30 is also equipped with an alarm wire 38. Receiver bracelet 30 features receiver photovoltaic cells 42. In an alternative embodiment, receiver bracelet 30 is equipped with a GPS tracking chip 44.

Receiver wristband 40 can be made of any suitable material, including, but not limited to: cotton, plastic, nylon, hypoallergenic fiber, rubber, silicone, viscoelastic foam, EVA foam, closed cell resin foam, or other suitable material.

The alert panel 34 is centered on the receiver face 46 of the receiver bracelet 30. Above the alert panel 34 is receiver LED panel 32. Below the alert panel 34 is the GPS chip 44. The alarm wire 38 and the receiver photovoltaic cells 42 are located on the receiver wristband 40.

In an embodiment the receiver bracelet 30 can be waterproof.

Both the transmitter LED panel 12 shown in FIG. 1 and receiver LED panel 32 shown in FIG. 2 display pertinent information, such as the time of day. When the activation button 14 of the transmitter 10 has been depressed, the alert panel 34 of the receiver bracelet 30 becomes backlit and flashes thereby communicating an alert to the wearer. At the same time, the vibration function 36 of the receiver is activated to send a vibrational signal to the wearer. The vibration function 36 begins to vibrate at a specified time interval after the activation button 14 has been depressed. The specified time interval can be any desired time interval, but one, two, three or up to five minutes is contemplated. The vibration function 36 continues to vibrate at regular intervals until the original alert has been deactivated by pressing deactivation button 20 on transmitter bracelet 10. The transmitter photovoltaic cells 22 supply power to the transmitter bracelet 10 upon exposure to sunlight. The receiver photovoltaic cells 42 supply power to the receiver bracelet 30 upon exposure to sunlight. Alternatively, the transmitter bracelet 10 and receiver bracelet 30 can be powered by batteries. Any suitable battery power source is contemplated, such as alkaline, rechargeable alkaline, lithium ion, and other suitable batteries.

If the receiver bracelet 30 has been removed from the wearer, alarm wire 38 on the receiver wristband 40 sends an alert to the transmitter bracelet 10. GPS chip 44 of the receiver bracelet 30 can be utilized to track the whereabouts and movements of the receiver bracelet 30.

In an alternate embodiment, transmitter bracelet 10 is capable of transmitting alerts to a multiplicity of receiver bracelets 30 simultaneously, providing for coordination of multiple individuals.

In a second alternate embodiment, both transmitter bracelet 10 and receiver bracelet 30 are capable of interfacing with different power sources, including, but not limited to: alkaline batteries, rechargeable alkaline batteries, rechargeable lithium ion batteries, USB or mini-USB chargers, and AC adapters. Transmitter bracelet 10 comprises transmitter charger port 52 and receiver bracelet 30 comprises receiver charger port 62. Both transmitter charger port 52 and receiver charger port 62 are configured to receive AC adapter, USB or mini-USB charger (not shown.)

The transmitter bracelet 10 and receiver bracelet 30 have multiple applications. They can be employed by parents or caretakers to enhance supervision and safety of children. They can also be used in personal or clinical settings, to enhance supervision and safety of the elderly, disabled, or anyone prone to disorientation or wandering. The transmitter and receiver bracelet also simplify planning and logistics for groups enjoying outdoor recreational activities such as camping, hiking, hunting, or fishing. Additionally, they can enhance coordination of groups that regularly disperse and reconvene, such as tour groups, emergency assistance organizations, fire fighters, search and rescue personnel, police organizations, and military.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A personal communication alert device comprising: a transmitter bracelet, consisting of a transmitter wristband, transmitter face, and transmitter battery compartment, wherein the transmitter bracelet further comprises transmitter LED panel and an alert activation button, an LED, a vibration activation button, a deactivation button and transmitter photovoltaic cells: and a receiver bracelet, consisting of receiver wristband, receiver face, receiver battery compartment, receiver LED panel, an alert panel, a vibration function, an alarm wire, and receiver photovoltaic cells.

2. The personal communication alert device of claim 1 wherein the alert activation button is centered on the transmitter face of the transmitter bracelet, and further transmitter LED panel is situated above the alert activation button when the user is looking at the LED panel, the alert activation button is positioned to the left of the LED, and further vibration activation button is positioned to the right of the alert activation button; and further the deactivation button is positioned below the alert activation button, and further the transmitter photovoltaic cells are situated on the transmitter wristband: and further the alert panel is centered on the receiver face of the receiver bracelet, and the receiver LED panel is positioned above the alert panel and further the alarm wire and the receiver photovoltaic cells are located on the receiver wristband.

3. The personal communication and alert device of claim 1, further comprising a GPS chip in the receiver bracelet.

4. The personal communication and alert device of claim 3 wherein the GPS chip is positioned below the alert panel.

5. The personal communication and alert device of claim 2, further comprising a GPS chip in the receiver bracelet.

6. The personal communication and alert device of claim 5 wherein the GPS chip is positioned below the alert panel.

7. The personal communication and alert device of claim 1, wherein the receiver wristband is made of any suitable material, including, but not limited to: cotton, plastic, nylon, hypoallergenic fiber, rubber, silicone, viscoelastic foam, EVA foam, or closed cell resin foam.

8. The personal communication and alert a device of claim 1, wherein the receiver bracelet is waterproof.

9. The personal communication and alert device of claim 1, wherein the transmitter bracelet is waterproof.

10. The personal communication and alert device of claim 2, wherein the receiver bracelet is waterproof.

11. The personal communication and alert device of claim 12 wherein the transmitter bracelet is waterproof.

12. The personal communication and alert device of claim 1 wherein the transmitter LED panel and receiver LED panel display pertinent information, such as the time of day.

13. The personal communication and alert device of claim 1 wherein the alert panel of the receiver bracelet becomes backlit and flashes when the activation button of the transmitter bracelet is depressed thereby communicating an alert to the wearer.

14. The personal communication and alert device of claim 13, further wherein when the activation button of the transmitter bracelet is depressed, the vibration function of the receiver is activated to send a vibrational signal to the wearer.

15. The personal communication and alert device of claim 14, wherein the vibration function of the receiver bracelet begins to vibrate at a specified time interval after the activation button of the transmitter bracelet is depressed.

16. The personal communication and alert device of claim 15 wherein the specified time interval is one, two, three or five minutes, and further wherein the vibration function continues to vibrate at regular intervals until the original alert has been deactivated by pressing deactivation button on transmitter bracelet.

17. The personal communication and alert device of claim 1, wherein transmitter photovoltaic cells supply power to the transmitter bracelet upon exposure to sunlight, and wherein receiver photovoltaic cells supply power to the receiver bracelet upon exposure to sunlight.

18. The personal communication and alert device of claim 1, wherein the transmitter bracelet and receiver bracelet are powered by batteries.

19. The personal communication and alert device of claim 1 wherein the alarm wire on the receiver sends an alert to the transmitter bracelet if the receiver bracelet is removed from the wearer.

20. The personal communication and alert device of claim 1 wherein transmitter bracelet is capable of transmitting alerts to a multiplicity of receiver bracelets simultaneously, providing for coordination of multiple individuals.
